(19) United States
(12) Patent Application Publication
(10) Pub. No.: US 2004/0230662 A1
(43) Pub. Date: Nov. 18, 2004

(54) System and method for sending and receiving large messages in a collaborative work environment

(76) Inventors: Julio Estrada, Carlisle, MA (US); Stuart Clark, Londonderry, NH (US)

Correspondence Address: Rick A. Toering, Mintz Levin Cohn Ferris Glovsky and Popeo, Suite 900, 12010 Sunset Hills Road, Reston, VA, 20190, US

(21) Appl. No.: 10/778,127

(22) Filed: Feb. 17, 2004

Related U.S. Application Data
(60) Provisional application No. 60/447,323, filed on Feb. 14, 2003.

(51) Int. Cl. G06F 15/16

(52) U.S. Cl. 709/207; 709/206; 709/204

(57) ABSTRACT

A system and method is provided for sending and receiving large messages in a collaborative work environment. Large messages are broken into smaller chunks each having a sequence number. The chunks are stored in a queue until all chunks of a message are received. The chunks are then reassembled at the destination based on the sequence numbers.

### CROSS-REFERENCE TO RELATED APPLICATIONS

This Application claims priority from U.S. Provisional Patent Application Serial No. 60/447,323, filed Feb. 14, 2003, which is incorporated herein by reference. This application also claims priority to U.S. application Ser. No. 10/093,713, “Electronic Mail Application with Integrated Collaborative Space Management,” filed Mar. 11, 2002, which in turn claims priority to U.S. Provisional Patent Application Serial No. 60/347,236, “Electronic Mail Application with Integrated Collaboration Space Management,” filed Jan. 14, 2002, both of which are incorporated herein by reference. This application is also related to the following applications, all filed herewith: “System and Method for Message Sequencing in a Collaborative Work Environment,” Attorney Docket No. 24569-010; “System and Method for Encrypting and Authenticating Messages in a Collaborative Work Environment,” Attorney Docket No. 24569-013; and “System and Method for Message Downloading and Initializing in a Collaborative Work Environment,” Attorney Docket No. 24569-015.

### BACKGROUND OF THE INVENTION

Collaboration systems are typically known. These systems typically relate to electronic communications around an activity or project between two or more individuals. Conventional collaboration systems typically utilize unsecured, standard email. Although secure email is available, a number of problems have prevented its adoption in conventional collaboration systems.

Secure email typically requires manual email verification. A user is often required to remember and use additional passwords for certification. Certificate-based secure email systems are sometimes used. However, these email systems typically required users to exchange an unsecured certificate prior to sending secure email. This may be undesirable because it requires the user to perform additional steps prior to sending an email securely.

Many secure email systems are platform or system dependent. A user wishing to send a secure email to a user operating on a different platform or system may be unable to send the email securely.

Furthermore, messages being sent to one or more recipients are often too large to send over conventional email communication channels. The messages may be broken into several, smaller messages, however, these sending these several smaller messages may cause congested email traffic on the mail server.

Using email in a replicated collaborative environment may also introduce other transport problems. Networked systems typically rely on acknowledgements to keep distant replicated data stores in synch. Because of the long delivery times of email and the relatively high server cost of each email, acknowledgements are generally not acceptable. However, because emails can be dropped, duplicated, damaged, or received out of order, a method of reliably re-synchronizing email messages and processing them in correct order is necessary if email is to be a reliable delivery mechanism for replicated data stores.

Replication of email messages having attachments may lead to the replication of email viruses. Script macros or other executable files often attach themselves to email folders. These potentially dangerous files may be transmitted to multiple machines when replicating email messages.

Other problems and limitations also exist.

### SUMMARY OF THE INVENTION

The invention overcoming these and other limitations of existing systems relates to a system and method for providing a collaborative work environment.

According to an aspect of the invention, a system and method for initializing a collaborative workspace environment may be provided, enabling a user to create a collaborative workspace in their electronic mail application. This collaborative workspace may comprise, for example, a collaborative workspace folder (or project folder) that is created in the user's mailbox. The collaborative workspace may further comprise a number of collaborative object types, and a collaborative workspace module may create one or more sub-folders in the collaborative workspace folder that correspond to each of the collaborative object types.

According to some embodiments of the invention, a user may install the collaborative workspace system, on a client device or on a server. After installation, the system may automatically configure itself to function with the client device or server platform.

According to some embodiments, the system may provide a graphical user interface. The graphical user interface may be completely integrated with a client or server platform. A user may then create one or more projects within the collaborative workspace using the graphical user interface. According to some embodiments, the graphical user interface may be integrated with an email platform. According to other embodiments, the graphical user interface may be integrated into applications other than email, such as, for example, a web portal, or other application.

According to some embodiments of the invention, a user may send invitations to other users to join a created project, or may receive invitations from other users to join a project. An invitation may be sent by a first user via email. The collaborative workspace module may send the invited participant information to enable the collaborative workspace module to be integrated with the invited participant's electronic mail.

According to some embodiments of the invention, installation permissions may be provided to determine which users may perform certain actions. Permission roles may be defined and assigned to various users. Permission roles may define, for example, which users may set access controls, create projects, invite participants, and many other permissions. In some embodiments of the invention, custom permissions may be defined and assigned.

According to some embodiments of the invention, the first user and the invited participant(s) may not use the same electronic mail application. The collaborative workspace module may enable the first user to see the collaborative workspace in the first type of electronic mail application environment and the invited participant(s) to see the collaborative workspace in another type of electronic mail application environment.

Another aspect of the invention relates to encryption and authentication of messages in a collaborative workspace environment. According to some embodiments of the invention, a public key infrastructure (PKI) may be provided for encryption. The PKI may include public key encryption, symmetric key encryption, and/or digitally signed certificates from a trusted source. According to some embodiments of the invention, encrypted security may be provided across corporate networks. In some embodiments of the invention, additional security may be provided within a corporate network.

According to some embodiments of the invention, authentication and encryption may be provided at a client device. A user of a local system may register and a public/private key pair and a self-signed certificate may be generated. A set of communications may be initiated to authenticate the user.

According to other embodiments of the invention, authentication and encryption may be provided at a server device. A public/private key pair and certificate may be generated as part of the purchase and/or installation of the invention.

According to some embodiments of the invention, encryption may be used for all email communication. An additional “inbox” may be provided to users for sending and receiving secure email. Any email may be sent or received securely via that inbox and may be authenticated.

Another aspect of the invention relates to sequencing messages and synchronizing the messages in a collaborative workspace environment. Once a participant has downloaded the collaborative workspace, the workspace may use sequence numbers to keep track of exchanged messages. The workspace at each participant keeps sequence numbers for each message that have been sent by the participant and the number of messages that have been received by the participant. Sequence numbers may be stored in a table identifying the sender and receiver of each message. In some embodiments of the invention, sequence number table entries may be sent using the XML protocol.

According to some embodiments of the invention, the workspace at each participant may have an independent sequence counter. Each workspace may assign a sequence number to each message being sent. The workspace may assign the sequence number to each message before sending it and the sequence number may be sent by the workspace along with the message.

According to some embodiments of the invention, when a participant receives a message from another participant's workspace, a sequence number associated with that message may be stored. The workspace at the receiving participant may use the received sequence number to determine whether all messages have been received by the sending participant.

According to some embodiments of the invention, a missing message queue may be provided. If a recipient's workspace determines that a message is missing from any participant, a notation may be placed in the missing message queue for the recipient's software. The notation may indicate the message sequence number, the workspace from which the message should be requested, and a timeout interval.

According to some embodiments of the invention, messages may be fragmented. A message fragment queue may be used to store these fragments in message sequence order. The fragmented message may not be processed until all fragments have been received into the fragment queue.

Some messages may depend on items that are missing. According to some embodiments of the invention, a dependency queue may be provided. The dependency queue may store a message identification for the dependent message and an item identification for the item being depended on.

Messages are sometimes lost during transmission. According to some embodiments of the invention, a participant's workspace may send a request to the author of a message requesting the author's workspace to resend the missing message. An expiration time may be set. According to some embodiments, a workspace receiving a request to resend message may resend the requested message using information from the saved sequence numbers.

Another aspect of the invention relates to fragmenting large messages in a collaborative workspace environment. Some messages may be too large to send over conventional communication channels. Messages that are too large may be broken into several shorter message fragments.

According to some embodiments of the invention, each message fragment may have its own sequence number as if it were an independent message. Each message fragment may include its own sequence number as well as the sequence number of the first and last fragments of the message. This information may be transmitted using the XML protocol.

According to some embodiments of the invention, the maximum size of each message fragment may be configured on a node-by-node base, for example, during the setup configuration. In other embodiments, the maximum message size may depend on the mail gateway. In some embodiments, a default fragment size may be set.

According to some embodiments of the invention, message fragments may be reassembled at the destination once all fragments have been received. Any missing fragments may be requested based on the missing fragment's message sequence number.

Large messages that are broken into many small fragments may cause congested email traffic on the mail server. According to some embodiments of the invention, congestion may be minimized by sending the message fragments gradually, instead of all at once.

Another aspect of the invention relates to preventing computer viruses from being replicated in a collaborative workspace environment. According to some embodiments of the invention, no programmatic posting mechanism is provided. Without the posting mechanism, virus replication may be prevented.

In other embodiments of the invention, a mechanism may be provided to detect whether posts to a project were performed through the user interface or generated programmatically. The mechanism may only allow posts from the user interface. The mechanism may allow authorized programmatic posts.

According to some embodiments of the invention, posts are scanned for executable files. Any untrusted executables may be disallowed. In other embodiments, a user may be notified of an untrusted executable file. The user may then confirm the post. In some embodiments, untrusted executables that are posted may not be replicated.

According to some embodiments of the invention, anti-viral security provided by the underlying email application may be relied upon.

Other objects and features of the invention will become apparent from the following detailed description considered in connection with the accompanying drawings that disclose embodiments of the invention. It should be understood, however, that the drawings are designed for purposes of illustration only and not as a definition of the limits of the invention.

### BRIEF DESCRIPTION OF THE FIGURES

FIG. 1 illustrates a schematic block diagram of a collaborative workspace environment according to one embodiment of the invention.

FIG. 2 illustrates a graphical user interface integrated with an email system, according to one embodiment of the invention.

FIG. 3 illustrates a graphical user interface integrated with a web portal, according to one embodiment of the invention

FIG. 4 illustrates a sample message inviting a participant to join a project, according to one embodiment of the invention.

FIG. 5 illustrates a flowchart for inviting a participant to join a project, according to one embodiment of the invention.

FIG. 6 illustrates a table of permissions and roles, according to one embodiment of the invention.

FIG. 7 illustrates a process for registering the collaborative workspace software and for authentication and encryption, according to one embodiment of the invention.

FIG. 8 illustrates an example of an LSBN table, according to embodiments of the invention.

FIG. 9 illustrates an example of an LSBI table, according to embodiments of the invention.

FIGS. 10A and 10B illustrate a flowchart for processing missing messages, according to some embodiments of the invention.

FIG. 11 illustrates a process for synchronizing messages, according to one embodiment of the invention.

FIG. 12 illustrates a sample fragmentation queue, according to some embodiments of the invention.

### DETAILED DESCRIPTION OF THE INVENTION

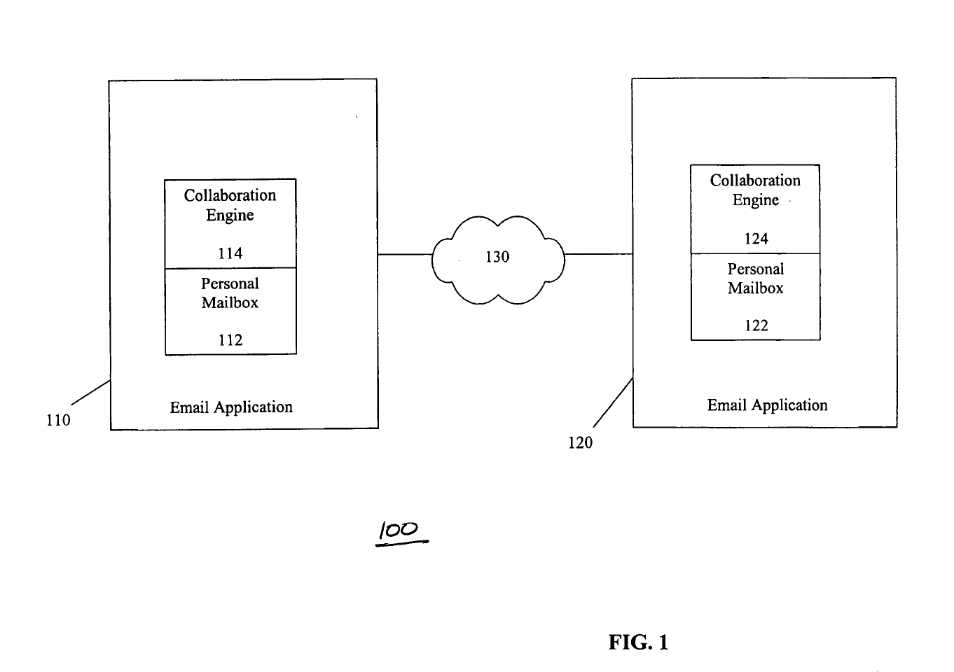

According to one aspect of the invention as illustrated in FIG. 1, a system 100 is provided for a collaborative workspace that is integrated with an email application. System 100 fully leverages an existing email infrastructure, allowing organizations to collaborate with each other regardless of application or platform. The system may also transparently incorporate standard public key infrastructure to authenticate users and encrypt messages, and may richly integrate with the user's email application to eliminate switching between an email application and a collaboration application.

System 100 may include one or more email applications 110, 120. Email applications 110, 120 may communicate with each other over a network 130. Integrated with email applications 110, 120 may be personal mailboxes 112, 122, and collaboration engines 114, 124. System 100 may be installed on a device serving as a client or as a server. Personal mailboxes 112, 122 may include one or more mailboxes including outboxes, inboxes, project storage, and other mailboxes. Personal mailboxes 112, 122 may directly interface with electronic mail applications 110, 120 for sending email through an outbox and receiving email through an inbox. The mailboxes may communicate with collaboration engines 114, 124. Collaboration engines 114, 124 may add project storage for enhanced collaborative features such as, for example, project spaces, threaded discussions, files, project calendar, tasks, and other features. Collaboration engines 114, 124 may ensure that project spaces within personal mailboxes 112, 122 remain synchronized.

According to some embodiments of the invention, email messages may be shared within the collaborative workspace based on keywords. When a message is sent, keywords in the “To”, “From”, “Subject” lines of the message as well as keywords within the text of the message may be used to determine which recipients should receive the message or which project to associate the message with. In other embodiments, embedded code within the email platform may be used for determining which project and/or user to send a message to.

According to some embodiments of the invention, a graphical user interface may be provided. A user may create one or more projects within the collaborative workspace using the graphical user interface. The graphical user interface may be integrated with, for example, an email platform, a website portal, or other applications.

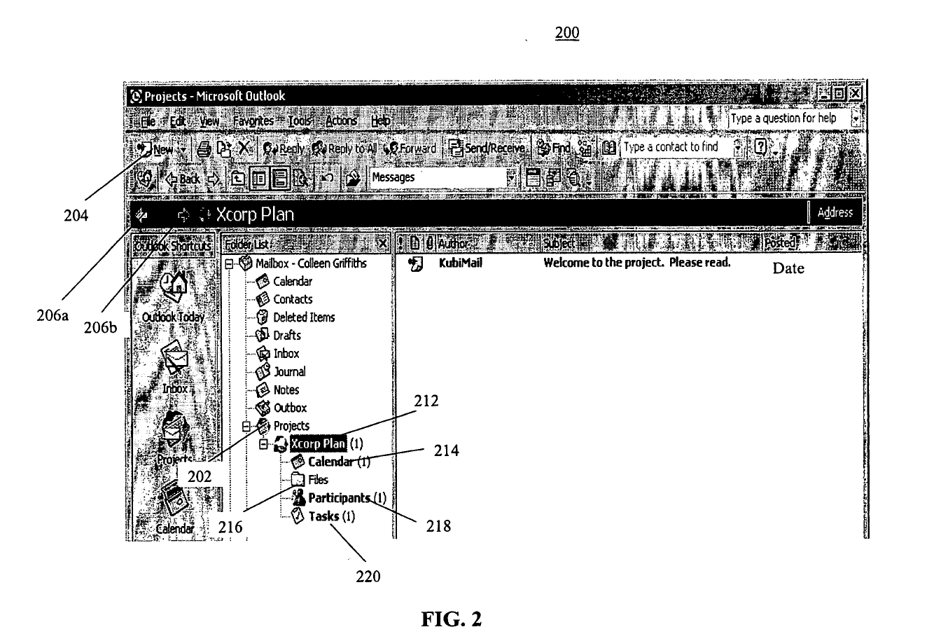

FIG. 2 illustrates a graphical user interface 200 may be integrated with an electronic mail platform, according to some embodiments of the invention. A Projects folder 202 may be created within a user's mailbox. If the user selects the Projects folder, particular functionality related to projects may be applied to standard tools provided with the email platform. For example, a New button 204 may be used to create a new project within the Projects folder 202. Additional tools may also be provided, such as, for example, navigation buttons 206a, 206b that enable a user to navigate among a plurality of projects.

A project titled Xcorp Plan is illustrated in graphical user interface 200. The project titled “Xcorp Plan” may be created as a subfolder 212 in the Projects folder 202. Subfolder 212 may include a calendar 214, files 216, participants 218, tasks 220, and other project related folders.

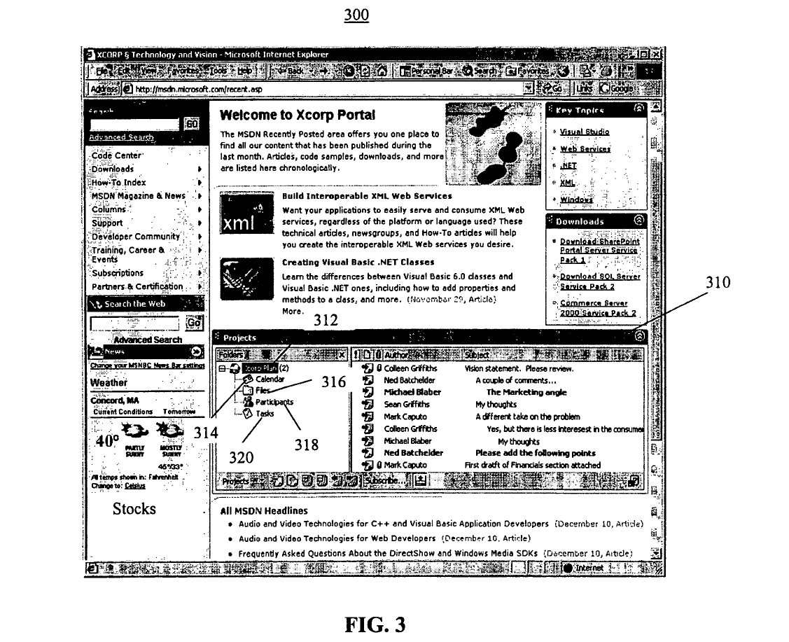

A graphical user interface 200 may also be integrated with a website portal 300, as illustrated in FIG. 3. A projects section 310 may be embedded in the corporate web portal 300. A project 312 titled Xcorp Plan is illustrated in portal 300. The project 312 may include a calendar 314, files 316, participants 318, tasks 320, and other project related folders. Files 316 may be any type of file created by a user, such as, for example, Microsoft Word, Excel, or PowerPoint documents, Adobe Acrobat files, graphic files, audio files, and other files. These files may accessed directly from the email application.

According to some embodiments of the invention, a user may invite participants to join a project. In some embodiments of the invention, only a project leader may invite and add new users to a project. However, in some embodiments, other users may propose new members for the project. Proposals may be sent as email messages to the project leader, who may then decide to invite the proposed member(s). In other embodiments, all users may be able to invite new participants.

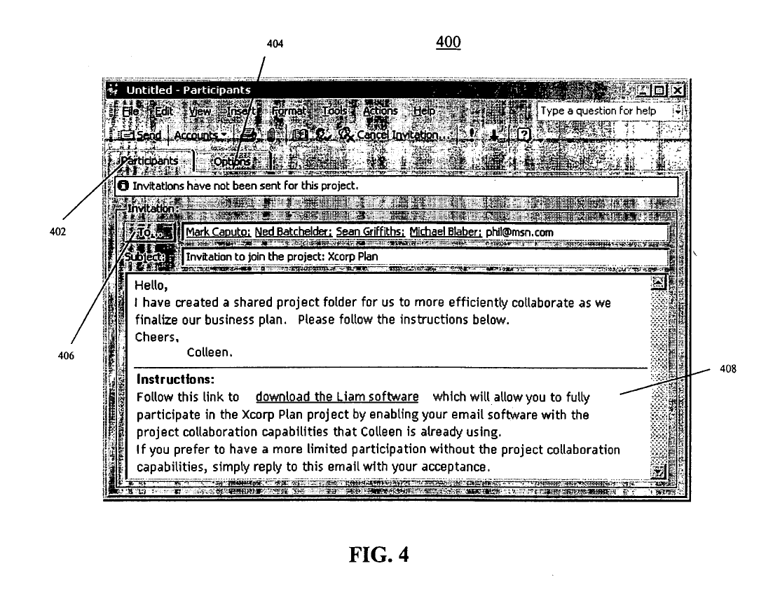

An electronic mail message 400 for inviting participants is illustrated in FIG. 4. Electronic mail message 400 may include a participants tab 402 and an options tab 404. Other electronic mail tabs may be provided, as would be apparent. Participants tab 402 may include a To field 406 that enables a user to input one or more user names to invite as participants to a project. The message 400 may also include an instructions section 408 including instructions for downloading the collaborative workspace software.

After the user has sent the invitation, the invited participants may be added to the project's participants folder 218 (illustrated in FIG. 2). A status indicator may be provided to indicate the status of the invited participant. For example, if an invitation has been sent to a user, but the user has not yet responded, the status may be “Invited”. If the user has accepted the invitation, the status may be listed as “Active”.

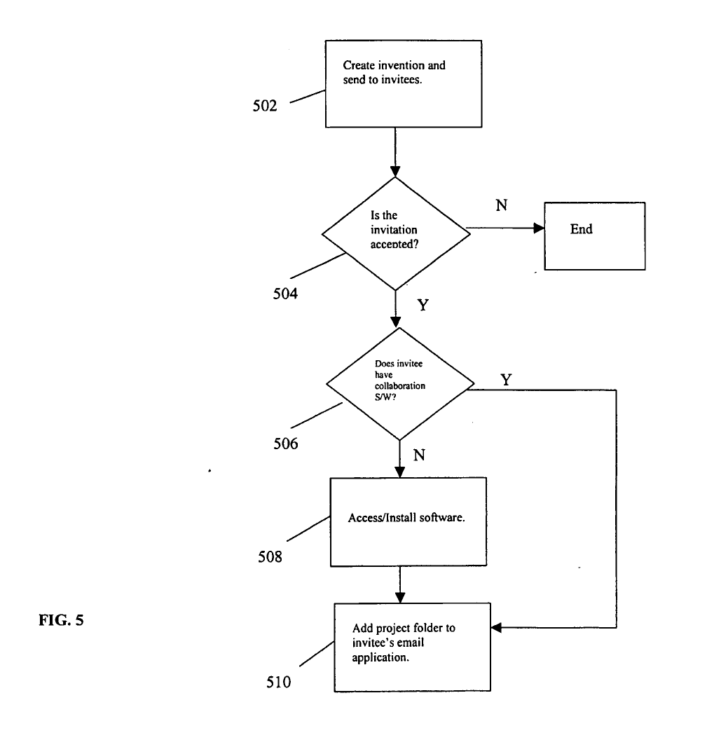

FIG. 5 illustrates a flowchart for inviting participants to a project. At an operation 502, a user may create an invitation, such as email message 400 to invite one or more participants and send the email to those one or more participants. The invitees may then accept or decline the invitation, as illustrated at an operation 504. If the invitation is declined, the process ends. However, if the invitation is accepted, the system may determine whether or not the invitees have the collaborative software installed, as illustrated at an operation 506. If the invitees do not have the software, the user may access and install the collaborative software system, as illustrated at an operation 508. Access and installation will be further described hereinafter. Once the software has been installed, a project folder may be added to the invitee's email application, as illustrated at an operation 510.

Predefined roles and access controls may be defined for each project participant. According to some embodiments of the invention, every project participant may receive, view, and edit all project related items. In other embodiments, only the original author of an item or a project leader may delete an item.

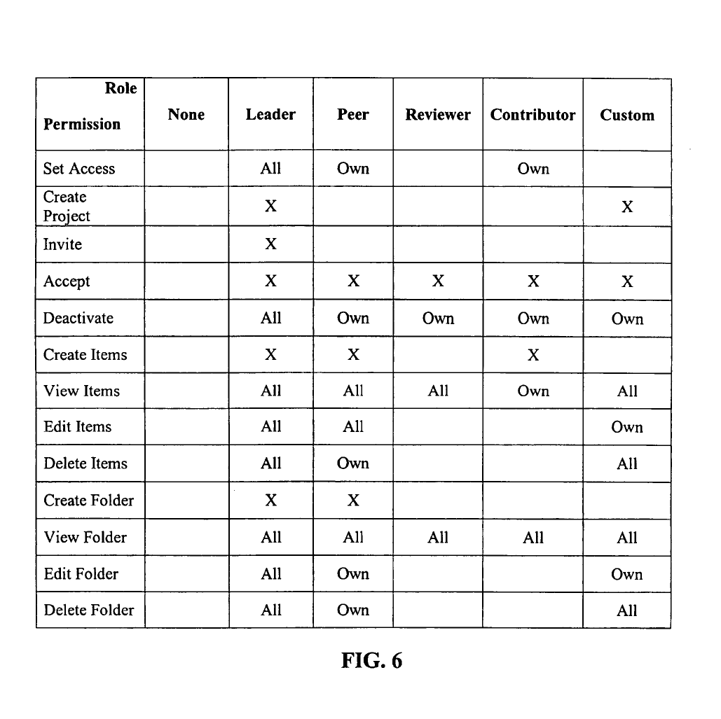

Permission role definitions may be used to define permission roles that may later be assigned to users. For example, permission roles may include, for example, project leader, peer, reviewer, contributor, or other roles. Custom permission roles may also be created. Individual permissions may be defined for each permission role. For example, a project leader may have permission to set access controls for all participants, create new projects, invite participants, and/or other permissions. FIG. 6 illustrates an example table of permissions 600. Other roles and permissions may exist, as would be apparent.

Access controls may be used to assign permissions to users and can associate those controls with a particular project or folder. In some embodiments of the invention, two access control folders may exist: installation controls and project controls. Access control folders and their contents may be invisible to those not authorized. The installation access control folder may be named, for example, “Installation Access Controls” and may be visible and editable only by system administrators. The project access control folder may be named, for example, “Project Access Controls” and may be found directly inside the project folder.

Each access control folder may include various fields per record including: participant (email address or email domain), project/folder, permissions, for, and owner. The participant field may refer to the participant or email domain that the permissions are being assigned to. The keyword “all” may be used in the participant field.

The project field may refer to the project the permissions apply to. The folder field may refer to the folder or subfolder the permissions apply to. The keyword “all” may be used in the project or folder field. The permissions assigned to a folder may apply to all the items in the folder and all its subfolders, unless the subfolders specifically override the permissions with their own permissions.

The permissions field may include a permission role definition defined above and may refer to the permissions assigned to the participant. The “for” field may be a restriction on who may be invited by the participant or which items the permissions apply to based on the item's owner. The keyword “all” may be used in the “for” field. If a participant has “set permissions” equal to “own” then the “for” field may be forced to be the same as the control owner field.

The owner field may have the email address of the participant that created (i.e., owns) the control. The owner field may be read-only and, according to some embodiments, may not be set by the user, but by the system administrator. The keyword “sysadmin” may be used to refer to the installation system administrator.

According to some embodiments, when a user creates a new project, their permissions for the project may be automatically set to leader for anyone, and all other participants may have peer permissions with anyone. The system administrator may own the leader's access control definition, and the participant's access controls may be owned by the project leader.

Access controls may be set based on the Set Access Controls permission. If the permission is “own,” users may update access control definitions that they own, and set access controls for items they own. If the permission is “all”, users may update all the access controls in the project, and set access controls for all the items.

An access control definition may not apply to the owner. If the access control owner also owns the folder it is applied to, then the access control may apply to adding new items or subfolders to the folder. Also in this case, if all the items in the folder are owned by the owner of the folder, they may restrict the visibility of the folder. This allows participants that are not leaders to create their own folders that only they may add items and subfolders to, and allows them to restrict the visibility of that folder to other participants.

In some embodiments, the project access controls may be replicated throughout the project. The installation controls may not be replicated. Access controls may be used locally to enforce permissions on that node. When a new permission role is defined, the new permissions may be checked against the current participant's permissions to make sure the participant has them. When a new access control entry is created, the participant field, folder field, for field and permissions may all be checked to make sure the current participant has those permissions for those participants, with those folders, for those addresses. The project access controls may be replicated on update like any other document. Installation access controls may be local to the installation and may not be replicated. Updates to project permissions may also be checked at the destination.

According to some embodiments of the invention, a user may participate in a project without installing the collaborative workspace software. These email only participants may become a participant in a project when replying to an invitation without downloading the software. Email participants may become a full participant at any time by downloading the software. In some embodiments, email participants may receive changes and/or additions to the collaborative workspace as email messages. In some embodiments, the email participants may receive daily and/or weekly summaries of the project.

According to one aspect of the invention, message encryption and authentication may be used in a collaborative workspace environment. Authentication and encryption may be provided at a client device. When a user of a local edition registers in accordance with various aspects of the invention, a client-side component on the user's machine may generate a public/private key pair and a self-signed certificate. In some embodiments, the private key may be stored on the client's machine. The self-signed certificate may be sent to the trusted source along with an email address associated with the client. The trusted source may send a digitally signed copy of the email address (signed using the trusted source's signature key) in an encrypted/signed email to that address. In addition, the trusted source may send a shared key to the client and may keep a copy for future communications. This shared key may be used in place of a password for subsequent authentication purposes when communicating with the trusted source. The client may receive the email and may store the digitally signed email address in a return email. It may also store the shared key in the client and in some embodiments also in the client's mailbox in a hidden file. Storing the shared key in the mailbox allows other client machines that have access to the mailbox to be authenticated when communicating with the trusted source.

If the email is not received by the client within some timeout, the user may be shown a verification error. If the email is received, the digitally signed email address may be sent digitally signed back to the trusted source by the client. The trusted source may then bind the public key to the email address using a certificate digitally signed by the trusted source and stores the certificate in a database for future reference. The trusted source may then send the certificate to the client, where the certificate may be subsequently stored. This process verifies that the machine with the private key has access to the to email address found in the certificate that includes the matching public key.

According to some embodiments of the invention, authentication and encryption may be provided at a server device. The public/private key pair and certificate may be generated and issued as part of a purchase and/or installation of the invention and may be bound to an email address of the corresponding server. The certificate may be marked as a server certificate for an entire email domain. As mentioned above, in some embodiments of the invention, the trusted source secures across the enterprise or domain, not across individuals within an enterprise or domain.

According to some embodiments of the invention, secure email may be implemented for all email communication. An additional “inbox” may be provided to users for sending and receiving secure email. Any email sent or received via the secure inbox is authenticated and secure. If an email cannot be securely delivered to a recipient, a message may be received by the sender identifying those emails that could not be delivered due to an insecure destination.

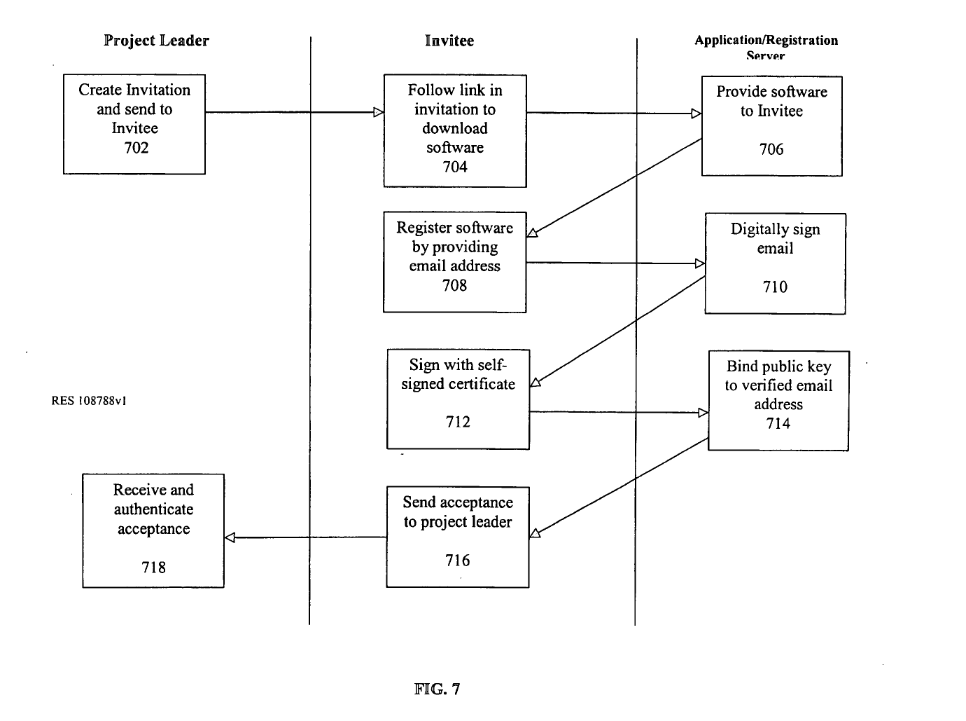

FIG. 7 illustrates a process for inviting a participant to join a project and authenticating the invitor and the invitee. A leader of a project space may wish to invite a user to join the project. The project leader may create and send an invitation to the invitee, as illustrated at an operation 702. At an operation 704, the invitee may read the invitation which may contain a link, such as a URL, to download the collaborative workspace software from an application/registration server to participate in the project. At an operation 706, the application/registration server may provide the software to the invitee.

Once the software has been downloaded, it may be registered by the invitee during the first use. As illustrated at an operation 708, the invitee may register the collaborative workspace software by providing an email address. The software program generates a public/private key pair and a self-signed certificate, and sends the email address and a certificate request to the software registration server. At an operation 710, the software registration server may, after receiving the registration information, digitally sign the email address using the registrations server's signature key and send it back to the invitee, encrypted using the public key in the self-signed certificate. At an operation 712, once the invitee's device has received the signed email address, it may be decrypted and sent back to the server after being signed by the self-signed certificate. At an operation 714, the may server issue and store a digitally signed certificate binding the public key to the verified email address. The invitee has now been registered.

Prior to notifying the project leader of the acceptance of the invitation, the project leader's authentication may be checked by the invitee's workspace by comparing the email address in the certificate with the one in the invitation header. Assuming the email addresses match, an acceptance command may be generated and the command may be encrypted, signed, and sent to the project leader's workspace, as illustrated at an operation 716. Once the project leader's workspace has received the acceptance command, the command may again be authenticated at an operation 718. The project leader's workspace may now send the encrypted project data to the invitee. The project leader's workspace may also send a command to other project participants' workspaces to add the new member to the project space. Normal project messages may now be shared and authenticated.

According to one aspect of the invention, a method for synchronizing messages and processing the messages in the correct order is provided for a collaborative workspace environment. According to an embodiment, synchronization may be based on having each node keep track of messages they have sent as well as messages they have received via a sequence number for every participant node in a project. Each node may include its own independent sequence counter. A node may represent a specific machine or address, or a replica of a project associated with a specific machine or address.

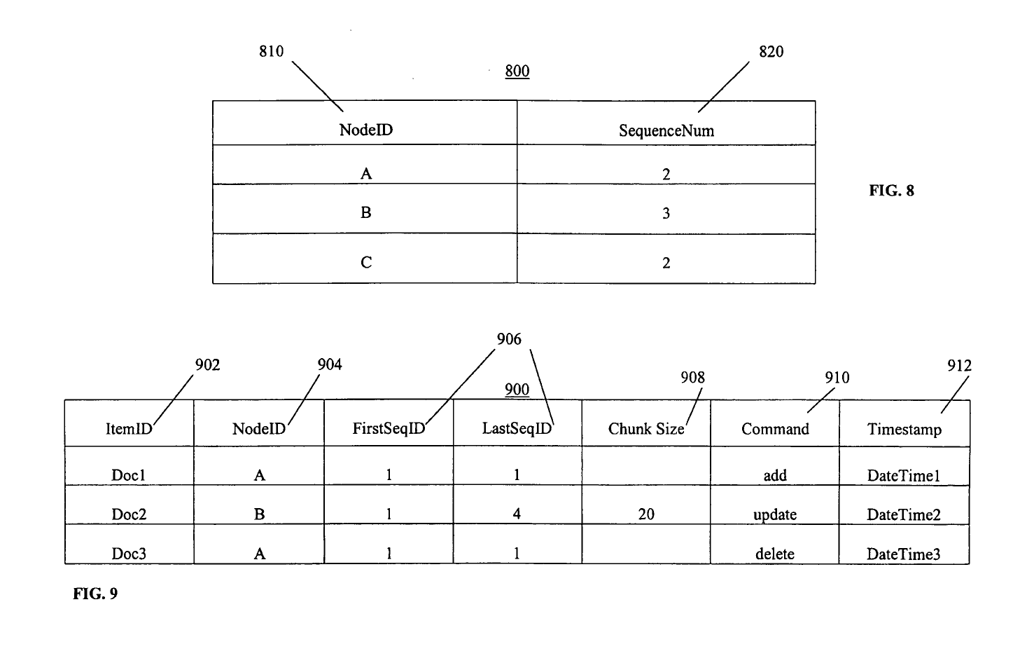

A Last Sequence by Node (LSBN) table 800, illustrated in FIG. 8 may be provided for storing sequence numbers with one entry for each node. LSBN table 800 may include a node identifier 810 for identifying the participant and a sequence number 820 representing the most recent message sequence number received from that node. Each node may also maintain a sequence number for the last message authored at that node. The sequence numbers may be stored persistently in LSBN table 800 with one entry for each node. Entries to the LSBN table may be updated whenever any sequence is received for a node that exceeds the current sequence in the table. According to some embodiments of the invention, the LSBN table may be sent along with each standard message using the XML protocol. A tag such as <MsgSequence> may be used to indicate the sequence information for the message currently being sent, while a tag such as <MsgSequenceList> may be used provide sequence information related to the other nodes.

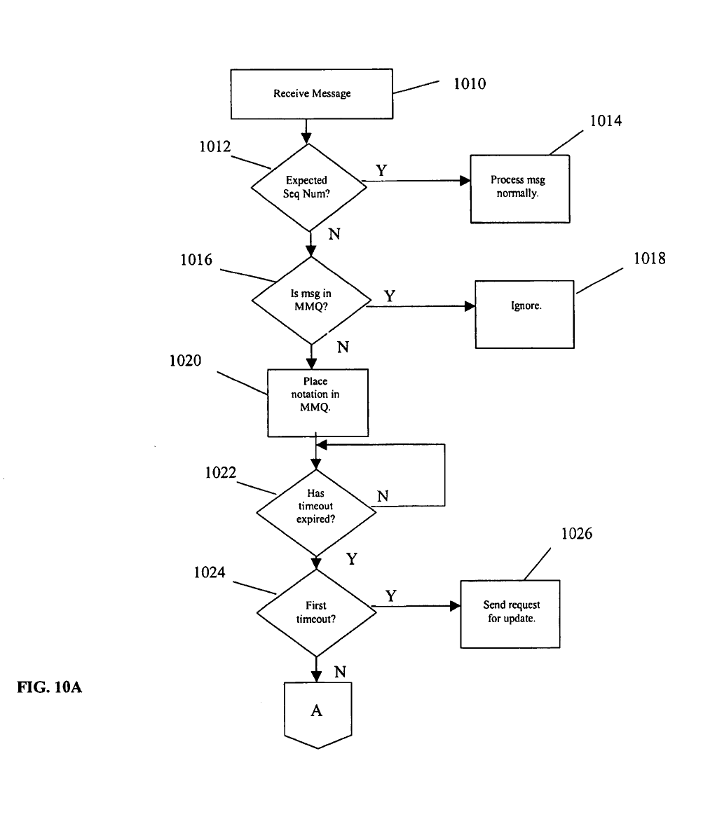

Each node may also maintain a Last Sequence by Item (LSBI) table 900, as illustrated in FIG. 9, that may include Item ID 902, Sending Node ID 904, Message Sequence(s) 906, Chunk Size 908, Command 910, and a Timestamp 912 that correspond to each item that has been authored or updated at that node in the project or that has been received from another node. The entries may be stored one row for each item. Sending node ID 904 may correspond to the ID of the node that last updated the item. Message Sequence(s) 906 and command 910 may correspond to the last sequence number and command sent or received/processed for that item. If the message sent for that item was fragmented then the range of sequence numbers (first and last) may be used, otherwise the first and last may be set to the same value. Chunk size 908 may be the chunk size that was used if the item was fragmented. This may be necessary, since the chunk size may vary from node to node, and any node may be used for resynchronization. Fragmented messages and chunking will be described in further detail hereinafter.

Timestamp 912 may correspond to the timestamp of the item at the time the entry was put in the table and may be used for disconnected resynchronization. The items may not be deleted from this table even though they may be deleted from the project. In addition, the deletion of an item may increment the revision number just like an update of the item thereby providing for the proper operation of out of order processing and resynchronization. Finally, if an item is not in this table, either an update or delete of the item may put an entry in the table. This table may be used by nodes to resend missing messages to other participant nodes. LSBI table 900 may be persistent in some embodiments and may be kept consistent with the state of the items.

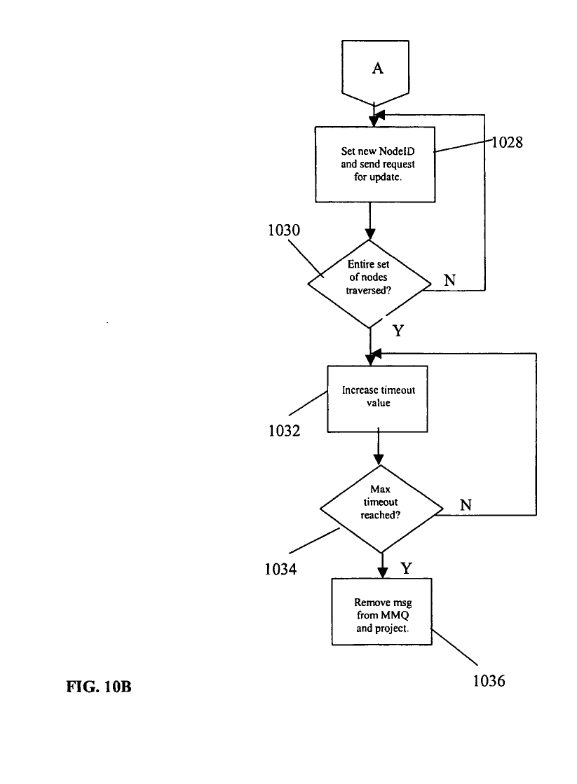

Sequence numbers may indicate that a recipient has missed one or more messages. If a recipient is missing any messages from other nodes, it may insert a notation in a missing message queue identifying the missing message, including an initial request timeout interval and an initial request node. The entries may each include the last editor node, the message sequence number, the node to request from, and a timeout interval value. FIGS. 10A and 10B illustrate a process for processing missing messages, according to some embodiments of the invention. As illustrated at an operation 1010, a node may receive a message. The system may then determine if the sequence number associated with the received message is the expected sequence number, as illustrated at an operation 1012. Since each node may maintain a sequence number for every message received from each node in the project, the system may determine that a message has been missed if the sequence number associated with the incoming message is not the next sequential sequence number. If the sequence number is as expected, no messages have been missed, and the node may process the message normally, as illustrated at an operation 1014.

If the sequence number is not as expected, a check may be made to determine if a notation has already been placed in the missing message queue for that particular message, as illustrated at an operation 1016. Only one entry per message may be placed in the missing message queue (MMQ), so if the message is already in the queue, it may be ignored, as illustrated at an operation 1018. If a notation has not been made in the missing message queue, a notation may now placed there, as illustrated at an operation 1020.

Associated with each entry in the MMQ may be a timeout value. The system may periodically check to see if the timeout value for a particular entry has expired, as illustrated at an operation 1022. A node that is missing a message may request an update from any node in the project. According to some embodiments of the invention, the request for update may not be sent until after a first timeout value expires, allowing time for ordinary replication and out of order processing to resolve before issuing the request for update. As illustrated at an operation 1024, a check may be done to determine if the first timeout has expired. If so, a request for update may be sent to the node specified in the MMQ entry, as illustrated at an operation 1026. If a subsequent timeout has occurred, a new node may be specified in the MMQ entry and a request for update may be sent to the new node, as illustrated at an operation 1028. If the node still does not receive the missing message, a check may be made to see if the entire set of nodes in the project have been traversed, at an operation 1030. If all nodes have not been traversed, processing may returns to operation 1028. If all nodes have been traversed, the timeout value may be increased at an operation 1032, and the nodes may be traversed again. A check may be performed to determine if a maximum timeout has been reached. If a maximum timeout has been reached, the message may be removed from the MMQ and from the project, as an operation 1036.

Some embodiments of the invention may adaptively determine the initial MMQ time out value per machine or node. During install, the value may be set to a large timeout to avoid unnecessary resends until a better timeout is determined. When a standard message is received and it removes a corresponding message from the MMQ, the amount of time that has elapsed since the MMQ entry was created may be calculated. This may be determined from the current time and the timeout value in the entry. This value may be compared to the current MaxDelay, which is initialized to 0 and the larger of the two may become the new MaxDelay. This may represent the maximum amount of time that missing messages were satisfied by standard replication and did not require a resend. In some embodiments of the invention, after some reasonable number of messages have been received and thereafter each time the MaxDelay changes, the initial MMQ Timeout my be set to twice the MaxDelay.

A node may sometimes fail abruptly, for example due to a power failure. After a node failure, a check may be performed to make sure the LSBN table and the LSBI table are consistent. The LSBI table may be searched by largest sequence for each node in it on restart. The result for each node may be compared to the LSBN table and if any node has a larger sequence, the LSBN table may be set to that value. The same check may be performed for the MMQ.

According to some embodiments of the invention, nodes may be able to resynchronize project data that has changed while a node was disconnected. A comparison may be performed of the timestamps in the LSBI table for locally authored items and the timestamp for each corresponding item on a node that is re-connected. If the timestamp on a item is newer than the one in the LSBI table, an update command may be generated for that item and executed. If an item does not exist in the LSBI table, an add command may be generated for the item and executed. If an item is in the LSBI table but missing in the project, a delete command may be generated and executed.

Some messages may depend on other messages. According to one embodiment, a dependency queue may be provided. A message that is dependent on missing items may be queued to the dependency queue. Each entry in the dependency queue may include a message identifier and an item identifier from which the message depends. When a message that has items that other dependency queue entries depend on executes, the corresponding pending message may now be executed as an incoming message as if it had just been received. The entries in the dependency queue for the fully satisfied and executed message may then be deleted.

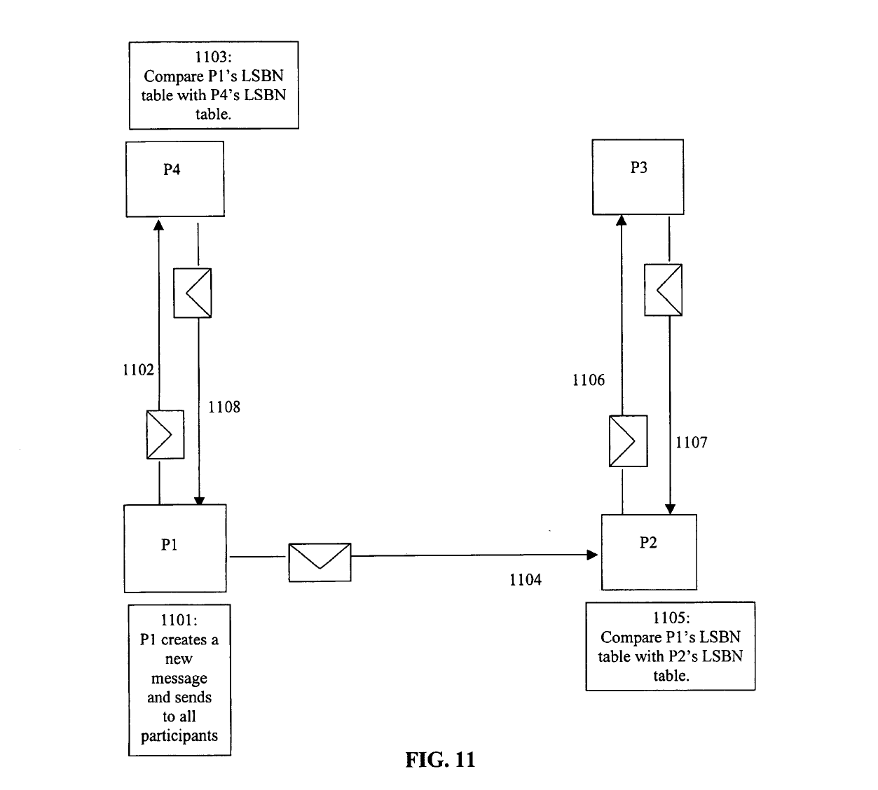

FIG. 11 illustrates an example process for synchronizing messages according to aspects of the invention. As illustrated, the current project has four participants, P1, P2, P3, and P4. P1 is missing a message M1, authored by P4. P2 is missing a message M2, authored by P3 and M1, authored by P4. At an operation 1101, P1 may create a new project message and send it to all project participants. The Last Sequence by Node (LSBN) table may be embedded as hidden command data into the newly created message before transmission. At an operation 1102, the message may be received by P4. At an operation 1103, the embedded LSBN table may be compared with P4's LSBN table. If the comparison indicates P4 has authored the message that the sender is missing, it may automatically send the message to the original sender. At an operation 1104, P1's new message may be received by P2. At an operation 1105, the embedded LSBN table may be compared with P2's LSBN table. If the comparison indicates P2 is missing messages, these messages may be put in the missing message queue. At an operation 1106, missing message M2 is automatically requested from P3. At an operation 1107, P3, the author of message M2, may automatically send message M2 to P2. At an operation 1108, P1 may receive missing message M1 and broadcasts a resynchronization message, enabling P2 to realize it is missing M1.

Using a collaborative workspace typically involves multiple editors which may result in conflicting documents. According to some embodiments of the invention, if an update arrives and is saved while another version the item is being edited, the messaging platform may signal an update conflict when the edited item is saved. In this case, the incoming item may win, and the edited item may be saved as a conflict copy in the same folder and may not be replicated. In some embodiments of the invention, conflicts may be resolved as “Newest Timestamp Wins.” In these embodiments, timestamps for replicated items with the same item ID may compared at a node, and the newest, or most recent, timestamp may win.

Other embodiments of the invention may utilize an editor node ID and a revision GUID that are generated for each item revision. When an item update comes in, first the node ID of the incoming item may compared to the node ID of the local item. If they match, then if the incoming timestamp is later, the update may be accepted; otherwise the update may be ignored. If they do not match, the previous revision GUID of the incoming item may be compared to the current revision GUID for the local item. If these GUIDs match, the items do not conflict; otherwise the item with the newest timestamp wins. The losing revision may be deleted if this node is not its editor node, and may be copied as a conflict item if it is. In these embodiments of the invention, when a client is reconnected after being disconnected, messages in the inbox may be processed in timestamp order thereby eliminating most false conflicts.

Some embodiments of the invention utilize author driven arbitration. In these embodiments, an editor node may send an update request to the author node. A previous and current editor node id-revision sequence number pair may be kept for each item. The current revision node id-revision number pair may be updated by an editor node whenever the item is updated. The previous revision node id-revision number pair may be set to the current revision pair by the author node if it accepts the update. When an author node gets an update request, it may compare the current node IDs of the two items. If they match, then if the incoming current revision is greater, the update may be accepted; otherwise the update may be ignored. If not, the previous node ID of the incoming item may be compared to the current node ID of the author's version. If they match, then the previous revision of the incoming item may be compared to the current revision of the author's version. If the incoming revision is greater than or equal to the author's revision, then the update may be accepted. In all other cases, the update may be rejected and the author node may send a rejection message to the editor node, which then may create a conflict copy for the item. If the update is accepted, the author node may replace the previous revision pair with the current pair and may broadcast the update to all the other nodes in the project.

Still other embodiments of the invention may utilize a revision node ID and a revision number. Like the author driven embodiments, a previous and current editor node ID-revision number pair may be kept for each item. The current revision node ID-revision number pair may be updated by an editor node whenever the item is updated. The previous revision node ID-revision number pair may be set to the current revision pair by the editor node whenever the editor node saves the item and it is not the current node for the item. Thus the previous pair may include the revision information for the last revision made by another node.

When a node receives an incoming update, it may compare the current node IDs of the two items. If they match, then if the incoming current revision is greater, the update may be accepted; otherwise the update may be ignored. If not, the previous node ID of the incoming item may be compared to the current node ID of the author's version. If they match, then the previous revision of the incoming item may be compared to the current revision of the author's version. If the incoming revision is greater or equal to the author's revision, then the update may be accepted. In all other cases, the update may be in conflict. Conflicts may be resolved by selecting the item with the newest timestamp. In the odd chance the timestamps are the same, then the item with the largest node ID may win. The losing update may be deleted if this is not the item's editor node, otherwise it may make it a conflict copy in the same folder. As with the GUID approach, when reconnecting the client after being disconnected, messages in the inbox may be processed in timestamp order in order to eliminate most false conflicts.

Another aspect of the invention relates to fragmenting large messages in a collaborative workspace environment. Some messages may be too large to send over conventional email communication channel. These messages may be broken into several shorter message fragments, each having its own sequence number. If a single attachment is too large for a message, the attachment may be broken up and a tag may be included in an XML message to indicate which portion of the attachment is included in the message.

According to some embodiments, the maximum size for each message fragment may be configured on a node by node basis, for example, in the setup configuration. In other embodiments, the maximum message size may depend on each mail gateway in the mail path. The fragment size that may be received may be larger than the size that can be sent. In some embodiments, a default chunk size may be set.

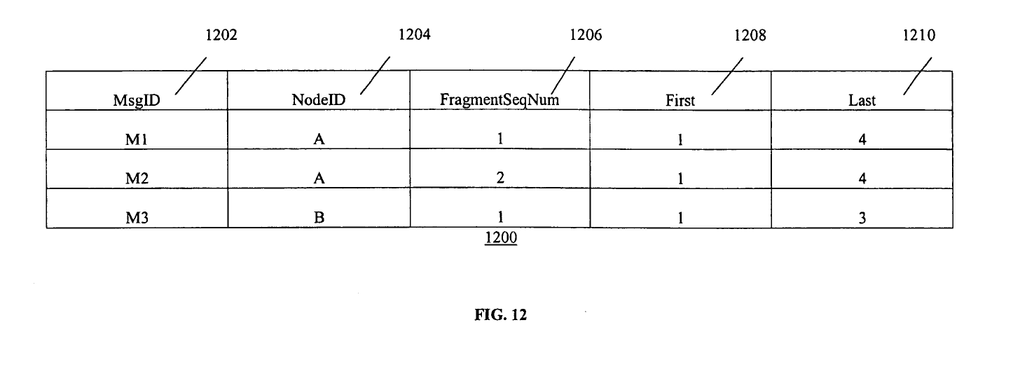

Each message fragment may include the sequence number of the first and last message fragments as well as its own sequence number. A fragment queue 1200, illustrated in FIG. 12, may be provided to store message fragments until all fragments have been received. Each entry in the fragment queue may include a message identifier 1202, a node identifier 1204, a sequence number for the fragment 1206, and the first 1208 and last 1210 sequence numbers for the complete message. When a new message fragment is put in the queue and the fragment completes the message, the message fragments may be coalesced into a single complete message which may be processed and the fragments removed from the queue.

Message fragments may be sent via the XML protocol similarly to the method used for sending complete messages. Fragments may be formed by including most of the XML in the first message fragment, and only fragment related xml in the subsequent message fragments. Messages may be broken up by distributing the complete file attachments among several messages.

A maximum chunk size for the project that would allow all participant nodes to receive any large message may be used as the minimum of all the node's chunk sizes. A node's chunk size may be the lesser of its outbound maximum message size and its inbound maximum message size. The chunk size of a node may be sent to the project leader along with the acceptance. The project leader node may set a new project chunk size if the new participant has a chunk size smaller than the current project chunk size. If the chunk size was reduced, the project leader node may send the new chunk size along with the new participant message to all the other participants and a project initialization message to the new participant. Because the new project chunk size arrives along with the new participant message, the node may save it locally before sending messages to the new participant. Old messages still in transit to other participants with the old chunk size may continue to work. Synchronization of large message that used the old chunk size may also continue to work with all nodes that were in the project when the original message was sent. All new large messages may use the new (smaller) chunk size. Nodes that can't fulfill a request due to chunk size may ignore the request. This may occurs in the event that a synchronization request is made to a new participant for a large message originally sent before the participant was part of the project.

In various embodiments of the invention, when a node attempts to fulfill a resend request, the node checks the requested chunk size against its own limit and not the project limit which might currently be smaller.

Reassembling message fragments is now described in accordance with various embodiments of the invention. Attached files may be reassembled at the destination when all message fragments have been received. Requests for missing fragments may be satisfied by recomputing the particular attachments, offsets, and lengths of the attachments in the missing message based on its message sequence number using processing similar to that performed when the message was originally fragmented.

The attached file fragments may be retrieved directly from the original files in the project using direct seeks and reads. Those attached file fragments may then be resent in a resend message with the appropriate fragment information in the xml.

All fragments within the span of fragments for the large message may be queued in the fragment queue until all of them have been received. The synchronization mechanism may automatically fill in missing fragments to ensure that the entire large message is sent intact. In addition, the message ordering mechanism in the queue ensures the fragments get reassembled into a single large message by sequence number.

Reducing congestion due to large messages or many messages are now described in accordance with various embodiments of the invention. Very large emails that break into many smaller email fragments or many small emails may cause congested email traffic on the mail server. In some embodiments of the invention, to minimize congestion, emails may be sent gradually instead of all at once. A timer may be used to separate emails or groups of emails. This time interval may be configured with a reasonable default as would be apparent.

Another aspect of the invention related to preventing computer virus replication in a collaborative workspace environment. According to some embodiments of the invention, an automatic detection mechanism may be provided to detect whether posts to the project were performed from the user interface or generated programmatically. These embodiments may only allow posts from the user interface and those programmatic posts that are authorized. These embodiments involving detecting the origination of the posts and authorizing those originated programmatically for both Outlook and Notes contexts.

Some embodiments of the invention may automatically detect whether posts were originated from the user interface or programmatically and scan posted items for executables, including, but not limited to, .exe, .bat, embedded macros, scripts, etc. Any “untrusted” executables may be disallowed. If an “untrusted” executable is found, the post may not be replicated. Other embodiments of the invention may automatically detect whether posts were originated from the user interface or programmatically and only allow posts from the user interface.

In still other embodiments of the invention, if an authorized program does not indicate an item is safe to be posted, the posted item may be scanned for executables. If an untrusted executable is found in the posted item, the user may receive a popup confirmation. The confirmation may warn the user that an untrusted executable was posted and ask for confirmation of the post. In some embodiments, authorized programmatic posts may be allowed while in other embodiments, no programmatic posts, even those that are authorized, may be permitted. The poster may receive a popup message indicating that programmatic posts are not allowed.

In yet still further embodiments, posted items may be scanned for executables. If an untrusted executable is found in a posted item, the post may not be replicated. These embodiments may not permit trusted executables to be sent.

In yet still other embodiments, no anti-viral action may be taken. Rather, the anti-viral security provided within the email system context may be relied upon. For example, if the invention operates within the context of Outlook 2002 (or later versions) and kept the corresponding macro security level is kept sufficiently high, the chances of Microsoft VB macro viral replication are greatly reduced.

According to one embodiment of the invention, any item containing Microsoft Office documents with embedded VBScript (Office versions 1997 onward) may not be replicated. In addition, this embodiment may also not replicate a file or an item with files attached that have Level I or “unsafe” file extensions. The check for preventing replicated Level I file extensions may be at the sender node, receiver node, and/or both nodes. Any attempts to replicate such items may result in the item being moved to a system folder named, for example, “Replication Errors” and the generation of an email to the user's inbox informing them of the error. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for sending a large message to each of a plurality of participants in a collaborative work environment comprising:
determining a number of message fragments in which to send the large message based on a predetermined maximum message size;
breaking the large message into said number of message fragments;
determining a first message sequence number corresponding to a first message fragment for the large message based on a maintained message sequence number;
determining a last message sequence number to accompany a last message fragment for the large message based on said first sequence number and said number of message fragments;
determining a message sequence number for each of said number of message fragments; and
sending a message for each of said number of message fragments, said message including said each message fragment and indicia corresponding to: said first message sequence number, said last message sequence number, and said message sequence number corresponding to said each message fragment.

2. The method of claim 1, where the predetermined maximum message size is set based on a minimum of a maximum message size associated with each of the plurality of participants.

3. The method of claim 2, wherein the predetermined maximum message size is adjusted if necessary to accommodate a new participant.

4. The method of claim 1 wherein message fragments are transmitted gradually to minimize network congestion.

5. The method of claim 4 wherein transmitting the messages gradually comprises:
configuring a timer to separate message fragment transmissions over a period of time.

6. A method for receiving a large message in a collaborative work environment comprising:
receiving a message including a message fragment and indicia associated with said message fragment, said indicia including a first message sequence number, a last message sequence number, and a message sequence number corresponding to said message fragment;
placing at least said received message fragment in a queue;
determining whether all message fragments have been received based on at least said first message sequence number, said last sequence number, and said message sequence number corresponding to said received message fragments; and
responsive to said determining that all message fragments have been received, assembling said message fragments into the large message.

7. The method of claim 6, wherein the message fragments are removed from the queue once all fragments have been received.

8. A system for receiving a large message in a collaborative work environment, the system comprising:
means for receiving a message including a message fragment and indicia associated with said message fragment, said indicia including a first message sequence number, a last message sequence number, and a message sequence number corresponding to said message fragment;
means for placing at least said received message fragment in a queue;
means for determining whether all message fragments have been received based on at least said first message sequence number, said last sequence number, and said message sequence number corresponding to said received message fragments; and
means for assembling said message fragments into the large message responsive to said means for determining that all message fragments have been received.
